(19) United States
(12) Patent Application Publication
(10) Pub. No.: US 2026/0101387 A1
(43) Pub. Date: Apr. 9, 2026

(54) METHODS FOR COORDINATION OF BS READER AND WTRU READER FOR AIOT SERVICE PROCEDURE

(71) Applicant: INTERDIGITAL PATENT HOLDINGS, INC., Wilmington, DE (US)

(72) Inventors: Guanzhou Wang, Brossard (CA); Samir Ferdi, Kirkland (CA); Michael Starsinic, Newtown, PA (US); Anuj Sethi, Ottawa (CA); Mohamad Kenan Al-Hares, Canterbury (GB); Alec Brusilovsky, Downingtown, PA (US)

(73) Assignee: INTERDIGITAL PATENT HOLDINGS, INC., Wilmington, DE (US)

(21) Appl. No.: 18/905,846

(22) Filed: Oct. 3, 2024

(51) Int. Cl. H04W 76/10; H04W 72/0446

(52) U.S. Cl. CPC H04W 76/10; H04W 72/0446

(57) ABSTRACT

A WTRU Reader assists AIoT devices by collecting AIoT device responses that are triggered by a BS Reader and forwards the AIoT device responses to the BS Reader. The BS reader collects capability information from WTRU Readers. The WTRU Reader is configured by the BS Reader with the information needed to perform AIoT device assistance, including time slot information. When the BS Reader triggers an AIoT device, the WTRU Reader monitors for AIoT responses, and forwards received response to the BS Reader.

### SUMMARY

A WTRU Reader assists AIoT devices by collecting AIoT device responses that are triggered by a BS Reader and forwards the AIoT device responses to the BS Reader. The BS reader collects capability information from WTRU Readers. The WTRU Reader is configured by the BS Reader with the information needed to perform AIoT device assistance, including time slot information. When the BS Reader triggers an AIoT device, the WTRU Reader monitors for AIoT responses, and forwards received response to the BS Reader.

In an embodiment, a WTRU Reader receives, from a base station (BS) reader, a request for an AIoT WTRU reader to perform a check-in procedure. The WTRU Reader transmits, to the BS reader, a radio resource control (RRC) connection request message including an indication of WTRU reader capabilities. The WTRU Reader receives, from the BS reader, an RRC connection accept message indicating the WTRU will perform WTRU reader functionality. The request for an AIoT WTRU reader to perform a check-in procedure may be a system information broadcast (SIB) message. The RRC connection request message may enable the BS reader to construct a list of available WTRU readers. The RRC connection request message may include a WTRU identifier, a 5G shortened temporary mobile subscriber identity (5G-S-TMSI), an application layer reader identifier, a supported AIoT service identifier, or a WTRU reader location. The RRC connection request message may include an AIoT device identifier of an AIoT device associated with the WTRU.

The WTRU Reader receives, from the BS reader, time slot configuration information indicating a time slot in which the BS reader will transmit to an AIoT device. The time slot configuration information may receive from the BS reader as part of a paging procedure. The WTRU Reader receives, from the BS reader, a paging message indicating the BS reader will transmit to the AIoT device in a next predefined time slot according to the time slot confirmation information.

The WTRU Reader monitors, during the indicated next predefined time slot, for a response message from the AIoT device. The TWRU Reader receives, from the AIoT device, an uplink response message responsive to a downlink device triggering message transmitted by the BS reader. The WTRU Reader then transmits, to the BS reader, the received uplink response message.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a signal flow diagram of a typical AIoT service procedure using Inventory as an example;

FIG. 3 is an illustration of a Target AIoT Device UL Device Response message being lost;

FIG. 4 is an illustration of a fast moving Target AIoT Device UL Device Response message being lost;

FIG. 5 is an illustration of a WTRU Reader assisting a Target AIoT Device by forwarding an UL Device Response to a BS Reader according to an embodiment;

FIG. 6 is a signal flow diagram of a SIB Broadcast for requesting a WTRU Reader to perform a check-in procedure with a BS Reader;

FIG. 7 is an illustration of system timing for an AIoT Service Procedure;

FIG. 8 is a signal flow diagram of a WTRU Reader paging procedure; and

FIG. 9 is a signal flow diagram of a WTRU Reader assisting a Target AIoT Device by forwarding an UL Device Response to a BS Reader.

### DETAILED DESCRIPTION

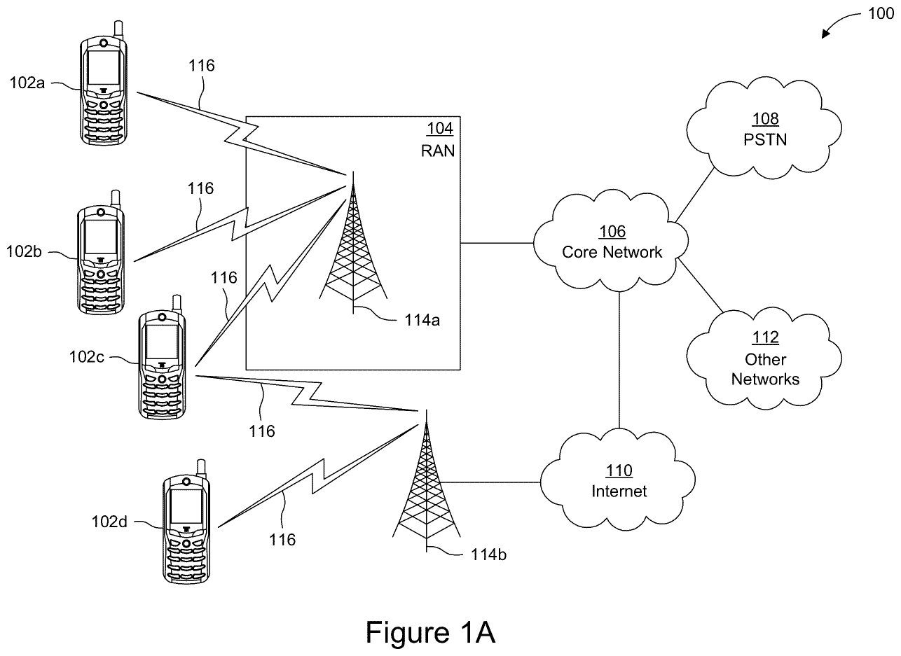

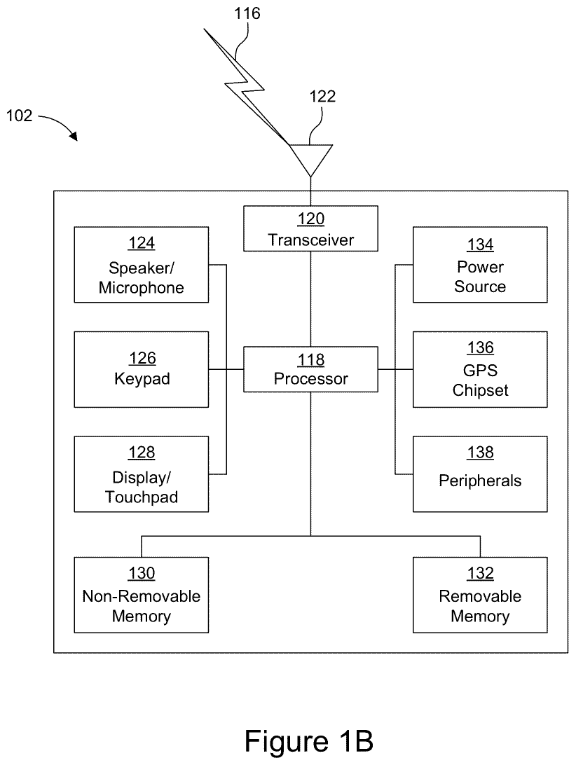

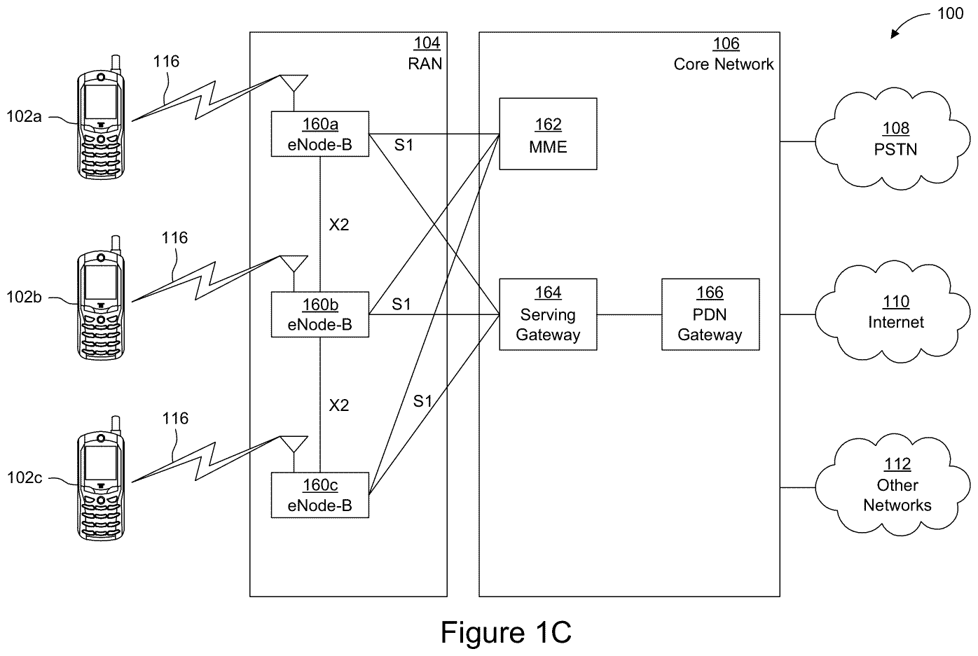

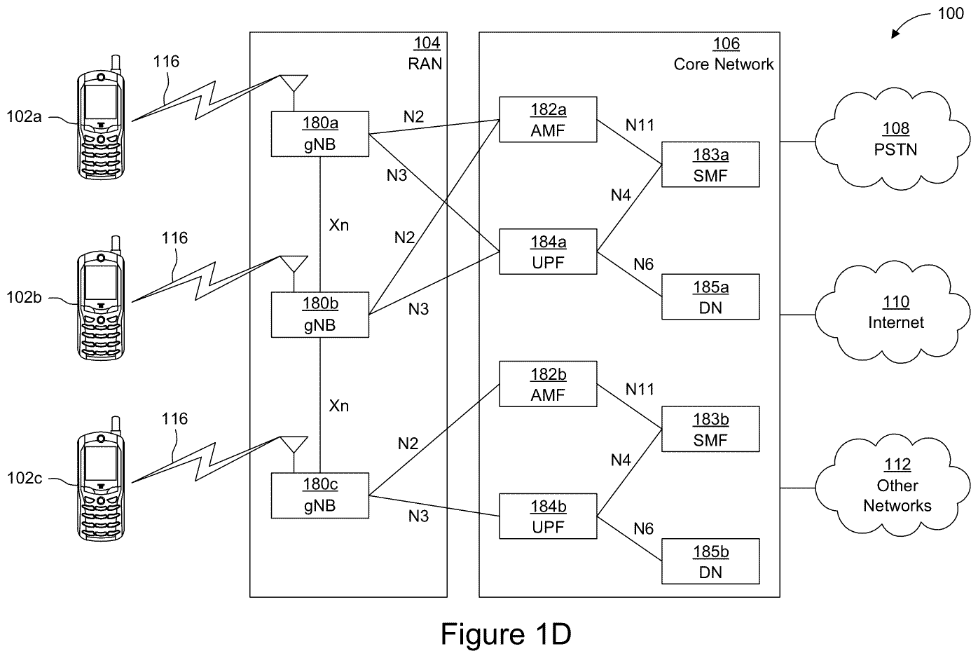

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following abbreviations and acronyms have the following meaning when used herein.

| | |
|---|---|
| 5GS | 5G System |
| 5G-S-TMSI | 5G Serving Temporary Mobile Subscriber Identity |
| AIoT | Ambient-power-enabled IoT |
| AMF | Access and Mobility Management Function |
| AS | Access Stratum |
| AF | Application Function |
| ALOHA | Additive link on-line Hawaii Area |
| BS | Base Station |
| CN | Core Network |
| DL | Downlink |
| gNB | Next Generation Node B |
| GPS | Global Positioning System |
| IoT | Internet of Things |
| NAS | Non-Access Stratum |
| NEF | Network Exposure Function |
| NF | Network Function |
| RA | Random Access |
| RAN | Radio Access Network |
| RF | Radio Frequency |
| RRC | Radio Resource Configuration |
| PLMN | Public Land Mobile Network |
| SIB | System Information Block |
| SFN | System Frame Number |
| TMSI | Temporary Mobile Subscriber Identity |
| UDM | Unified Data Management |
| UE | User Equipment |
| UL | Uplink |

### WTRU Wireless Transmit/Receive Unit (WTRU)

Additionally, the following terms have the following meaning when used herein. AIoT DL Triggering/AIoT paging: The procedure that an AIoT Reader broadcasts a signal or message to trigger one or a group AIoT devices to respond. The identifier of the target AIoT device or device group may be included in the triggering/paging message. The terms AIoT DL triggering, AIoT triggering, AIoT Paging are used interchangeably herein.

AIoT Device Response: The message that an AIoT device sends to the AIoT Reader in response to the AIoT DL Triggering/Paging message. The AIoT Device Response may be sent using an AIoT Random Access procedure.

AIoT Random Access (RA): Slot-ALOHA based procedure that allow AIoT devices to send messages in random time slots to avoid collision. The details of AIoT RA procedure are being studied in 3GPP RAN1 and RAN2 work group.

AIoT Reader: A WTRU or a RAN node that can communicate with AIoT devices via AIoT air interface. When a WTRU serves as an AIoT Reader, it is referred to as a “WTRU Reader” herein; when a RAN node serves as an AIoT Reader, it is referred to as a “Base Station Reader” herein.

Ambient IoT Function (AIoTF): This is a new 5G network function to support AIoT services; this function could be a standalone function or collocated with the AMF. This function is responsible for authentication and authorization of the AIoT devices, routing of the AIoT service requests/responses between the AIoT devices and AIoT-AF (via NEF).

Assisting Reader: an AIoT Reader (e.g. a WTRU Reader) that assists other Readers (e.g. a BS Reader) to complete an AIoT service procedure. For example, an Assisting Reader may help to collect AIoT device responses that are not triggered by itself and forward the device responses to another Reader that originally triggered the AIoT devices.

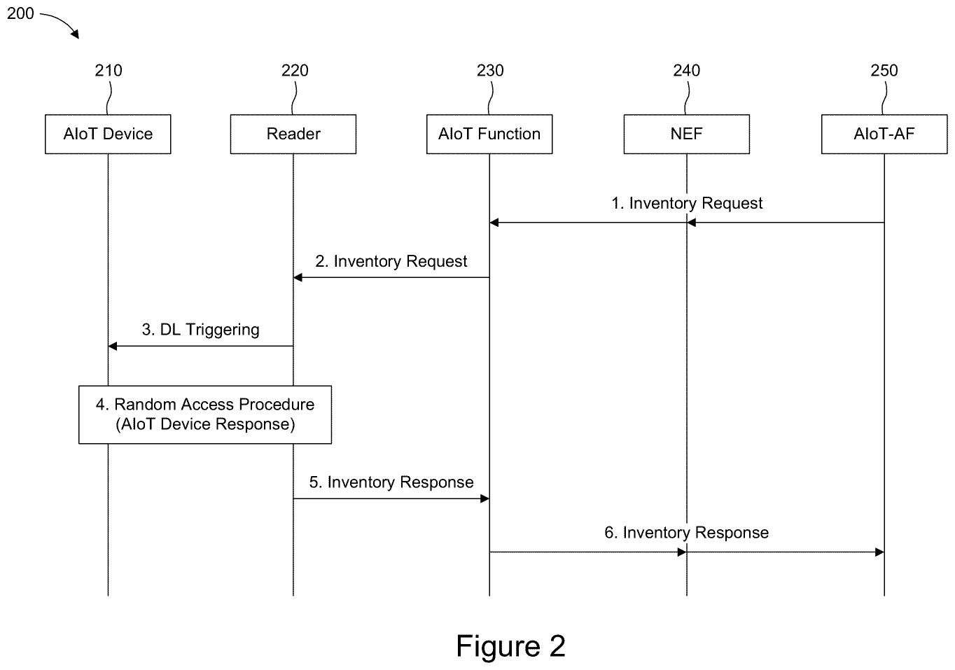

Referring to FIG. 2, a typical AIoT service procedure using Inventory as an example is illustrated. An AIoT-AF 250 sends an Inventory Request via NEF 240 to an AIoT Function 230 (signal 1). The AIoT Function 230 forwards the Inventory Request to an AIoT Reader 220 (signal 2). The AIoT Reader 220 sends a DL triggering message to the AIoT Device 210 (signal 3). The AIoT Device 210 performs a Random Access procedure with the AIoT Reader 200, where the an Inventory is provided to the AIoT Reader 220. The AIoT Reader 220 forwards an Inventory Response message to the AIoT Function 230 (signal 5). The AIoT Function 230 forwards the Inventory Response to the AIoT-AF 250 via the NEF 240 (signal 6).

A BS Reader has larger downlink coverage area than a WTRU Reader. When sending a DL triggering message or other request, a BS Reader can reach many AIoT devices in a large area. In the uplink, if an AIoT device is far from the BS Reader from which the triggering message has been received, the signal that the AIoT device sends in response to the triggering message may not be received by the same BS Reader because the AIoT device may have very limited transmitting power or even lacks a power amplifying device.

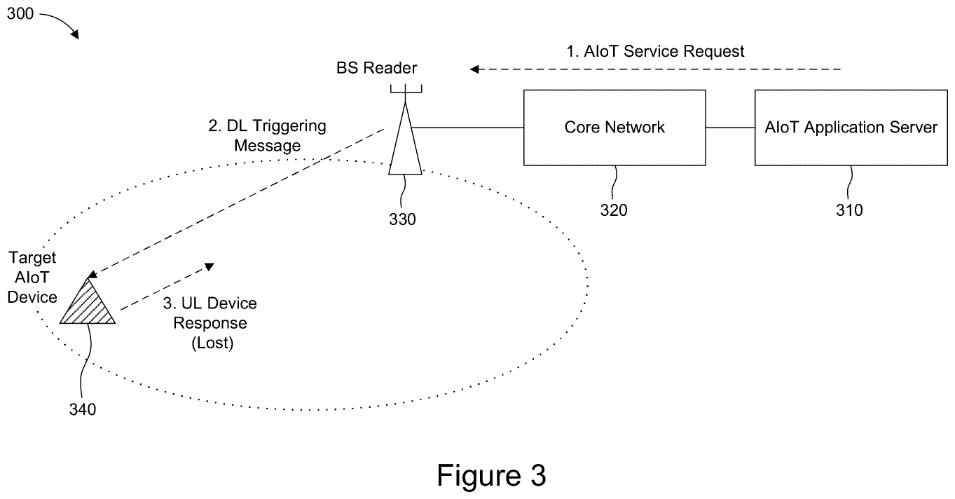

This is illustrated in FIG. 3, where the large coverage area of a downlink triggering message transmitted from a BS Reader results in an uplink response that is low power and does not reach the BS Reader. The signal flow diagram 300 shows an AIoT application server 310 sending an AIoT service request via a Core Network 320 to a BS Reader 330 (signal 1). The BS Reader 330 transmits a DL Triggering message to Target AIoT Device 340 (signal 2). The Target AIoT Device 340 transmits an UL Device Response message (signal 3) in response to the triggering message. Because the Target AIoT Device 340 is a low power ambient IoT device, the UL Device Response is lost because it cannot reach the BS Reader 330.

A WTRU Reader has a smaller downlink coverage area as compared to a BS Reader. Therefore, when using WTRU Readers, more WTRU Readers may need to be employed to reach AIoT devices in a larger area. Additionally, if the target AIoT device's location is not precisely known to be proximate to a certain WTRU Reader, more WTRU Readers need to be employed to cover possible locations to increase the chance of successfully reaching the target AIoT device. On the other hand, as a WTRU Reader is usually close to the target AIoT device that receives the DL triggering message, the AIoT device response transmission is more likely received by the WTRU Reader. Further, if an AIoT service requires frequent interactions with AIoT devices through a WTRU Reader, the WTRU's normal operations (for example, cellular communications) may be interrupted.

To address the above issues of using AIoT Readers to interact with AIoT devices, embodiments disclosed herein allow a BS Reader to be used for DL triggering operations while one or multiple WTRU Readers are used to receive UL responses from the AIoT devices and forward them to the initiating BS Reader. Accordingly, the BS Reader and the WTRU Reader(s) need to be properly coordinated to carry out AIoT service procedures.

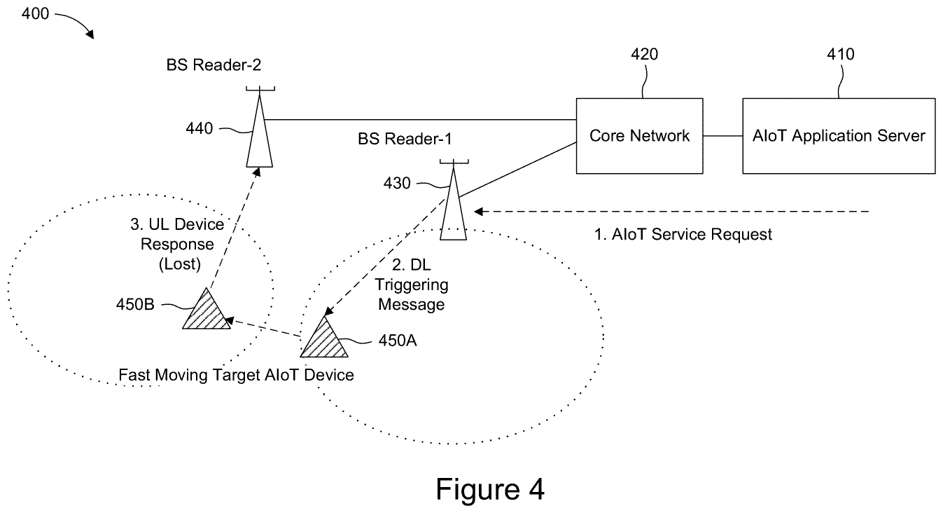

In another scenario, an AIoT device may receive a DL triggering message from one BS Reader or a WTRU Reader, but the AIoT device response may be received by another BS Reader or another WTRU Reader. For example, this may be because the AIoT device or the WTRU Reader itself is fast moving. It is important that the received AIoT device response is properly handled at the WTRU Reader that didn't send the DL triggering message, and the original BS Reader or WTRU Reader that sent the DL Triggering message be notified. As shown in FIG. 4, an AIoT service request message is sent from AIoT Application Server 410 via Core Network 420 to a BS Reader-1 430 (signal 1). The BS Reader-1 430 transmits a DL Triggering Message to a fast moving target AIoT device 450a (signal 2). When the fast moving target AIoT device 450b transmits an UL Device Response message (it is noted that AIoT device 450 is the same device, and the a and b designation indicates the device is at a different location), since the device 450b is at a different location the UL Device Response message would usually be lost (signal 3). However, BS Reader-2 440 receives the UL Device Response (signal 3).

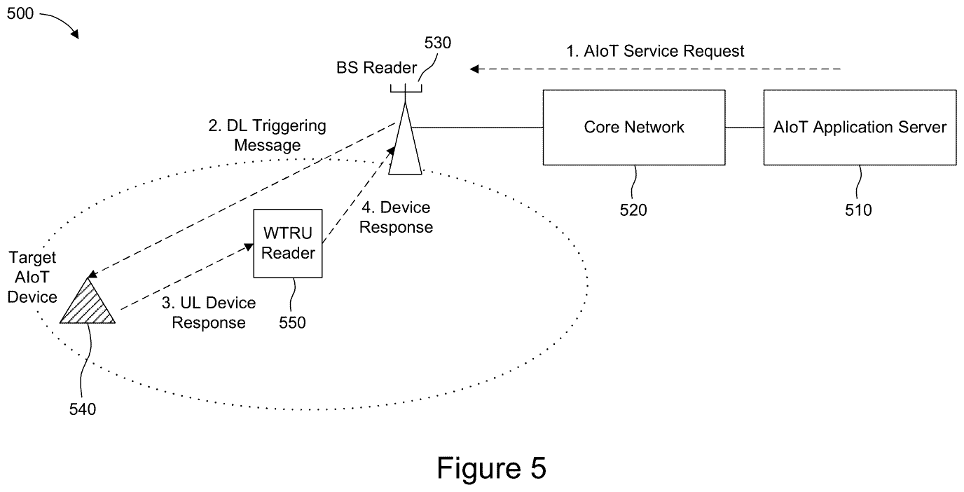

In the scenarios illustrated above with reference to FIGS. 3 and 4, coordination of a BS Reader and WTRU Readers for AIoT service procedures is necessary. In a first embodiment, related to the scenario described above with reference to FIG. 3, and now referring to FIG. 5, a BS Reader 530 is responsible for broadcasting downlink triggering messages for an incoming AIoT service request messages from an AIoT Application server 510 received via a Core Network 520 (signal 1). A Target AIoT device 540 receives the DL Triggering Message (signal 2) and transmits an UL Device Response (signal 3). The UL device response (signal 3) may be received by one or multiple WTRU readers 550 (note that only one is shown in FIG. 5). The WTRU reader 550 that receives the UL Device Response may forward the response to the BS reader 540 (signal 4). The BS reader 530 will then send the AIoT service response to the AIoT Application Server 510 through the Core Network 520. The WTRU Reader 550 that assisted may be referred to as an “Assisting Reader”.

For the above described embodiment to operate properly, the BS Reader 530 needs to be configured with a list of the WTRU readers (like WTRU Reader 530) that are in the BS coverage area and are able to assist AIoT service procedures. This can be done in a few ways described below.

In one embodiment, the BS Reader may be informed by the Core Network about the WTRU Readers that are available in the BS coverage that are capable of assisting AIoT devices. The network may provide this information based on the WTRU's subscription information or capability report for example, obtained during a WTRU registration procedure or a reader authorization procedure) and the WTRU's location (for example, whether the WTRU is in the coverage of the BS Reader). For example, after a WTRU is authorized by the Core Network to serve as a WTRU Reader and the WTRU supports AIoT device assistance as described herein, the Core Network may inform a BS Reader that such a WTRU Reader is available. The BS Reader may compile and maintain a list of capable WTRU Readers based on the information from the Core Network. The Core Network may also inform the BS Reader when a capable WTRU Reader leaves the BS coverage or is no longer authorized as a WTRU Reader, and the BS Reader may update its list accordingly. Note that as the Core Network may not be aware when a WTRU Reader leaves the BS coverage (for example, when the WTRU leaves without performing a mobility update procedure), the available WTRU Reader list in the BS Reader may not be accurate.

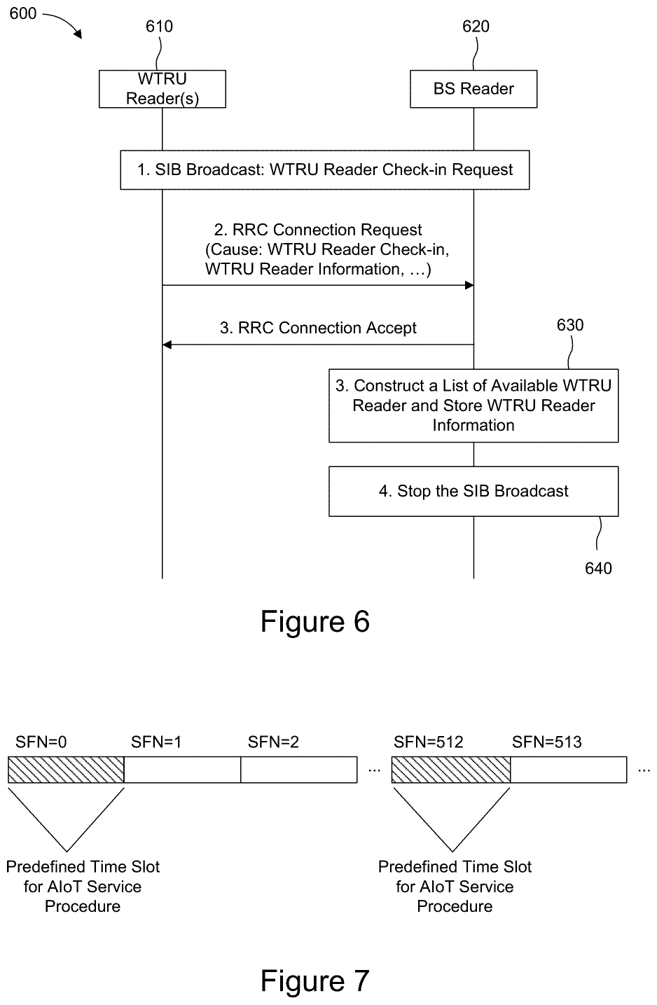

In another embodiment, referring to FIG. 6, a signal flow diagram 600 begins with a BS Reader 620 broadcasting a special SIB information which requests all available WTRU Readers 610 to check in with the BS Reader 620 (signal 1). The SIB broadcast may last for a set period of time. Capable WTRU Readers 610 should monitor the presence of this special SIB and should initiate an RRC Connection with the BS Reader 620 after detection of the presence of the special SIB (signal 2). A capable WTRU Reader 610 may indicate the cause for RRC connection request is “WTRU Reader check-in”, for example. The capable WTRU reader may report to the BS Reader, for example in a RRC message, its WTRU identifier (for example, 5G shortened temporary mobile subscriber identity (5G-S-TMSI), application layer Reader Identity, supported Reader functionalities (including the capability to assist in AIoT procedure), supported AIoT service identifiers, WTRU Reader location, and/or other information. The WTRU Reader may also provide one or more AIoT device identifiers that it has detected (for example, AIoT devices that the WTRU has recently communicated with) and the timestamp that those AIoT devices are detected as part of WTRU Reader information. The BS Reader may inform the network (for example, the AMF/AIoT Function (AIoTF)) with an indication of the WTRU as a potential WTRU Reader candidate. The AMF/AIoTF may check whether the WTRU is authorized to act as a WTRU Reader based on WTRU subscription data and provide WTRU Reader selection assistance based on local policies. The AMF/AIoTF may inform the BS Reader about the list of authorized and eligible WTRU Readers (and those that not authorized or non-eligible UEs). For example, the AMF/AIoTF may determine that a capable WTRU is not adequate for receiving a device response. The determination by the AMF regarding WTRU (in) eligibility as a WTRU Reader may be, for example, based on the WTRU mobility pattern. For example, expected moving trajectory of the WTRU based on NWDAF analytics or a WTRU behavior moving trajectory parameter may be a factor in the AMF's decision. A WTRU with an expected moving trajectory that is fast moving (in other words, expected to quickly exit BS coverage) may be determined as ineligible, while a more stationary WTRU may be determined as an eligible WTRU Reader. The BS Reader may send a message to the WTRU (for example, an RRC Connection Accept message (signal 3) and/or an RRC reconfiguration message) to confirm the WTRU is selected as a WTRU Reader assisting the BS Reader. The message may include additional parameters needed by the WTRU to receive responses from specific AIoT devices (for example, AIoT device type and/or identity).

The BS Reader may then construct a list of capable WTRU Readers and store the related information. The BS Reader 620 may broadcast the special SIB periodically to obtain an up-to-date list of available WTRU Readers (step 630), or the BS Reader may broadcast the special SIB when there is an incoming AIoT service request so that the BS Reader can find assisting WTRU Readers. The BS Reader 620 may stop broadcasting the SIB based on various criteria (step 640).

In another embodiment, a WTRU Reader may proactively initiate an RRC Connection with the BS Reader to check-in and report WTRU Reader information. The WTRU Reader may perform this check-in procedure periodically, for example, based on a timer that's configured by the core network when the WTRU is authorized as a WTRU Reader.

The BS Reader may further forward the received WTRU Reader information to the core network (for example, an AIoT Function or Controller). The WTRU Reader information may be used by the core network for a few purposes. For example, the core network may determine whether a BS Reader or a specific WTRU Reader is selected to handle an incoming AIoT service request. If the WTRU Reader Information indicates that one WTRU Reader has recently detected the AIoT device that's the same as the target device of the incoming AIoT service request, the core network may choose this WTRU Reader to handle forwarding the incoming service request transmitted from the AIoT Device. Otherwise, the core network may choose the BS Reader so the BS Reader may try to reach the device in a broader area.

When there is an incoming AIoT Service Request received at a BS Reader, the BS Reader and other WTRU Readers that will assist in forwarding received AIoT Device responses need to synchronize. This synchronization will enable the WTRU Readers to start monitoring AIoT device responses at the same time that the DL triggering message is sent by the BS Reader. This synchronization can be achieved in several ways.

In one embodiment, the BS Reader may choose to perform AIoT service related procedures (for example, transmitting a DL triggering broadcast) at predefined time slots, for example, defined by System Frame Number and subframe number. These predefined time slots may be periodically repeating. For example, referring to FIG. 7, the BS Reader may choose to perform AIoT service related procedures at the beginning of SFN=0 and lasts 10 ms, and the BS Reader repeats AIoT service related procedures every 512 radio frames (i.e. 512 ms), in SFN=512, as shown in FIG. 7.

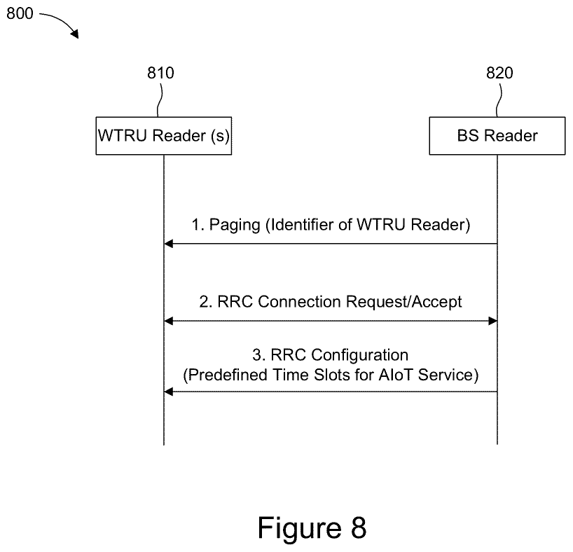

The BS Reader may communicate the predefined time slots for AIoT service related procedures to the WTRU Readers. For example, when a WTRU Reader checks-in and a RRC Connection is established, as described above with reference to FIG. 6, the BS Reader may send this predefined time slot configuration to the WTRU Reader. Referring to FIG. 8, a signal flow diagram 800 begins when the BS Reader 820 initiates Paging procedures to bring available WTRU Readers (based on the list of available WTRU Readers and Reader information as discussed above) to Connected mode. The BS Reader 820 sends a Paging message to a WTRU Reader 810 (signal 1). The predefined time slot information might be updated by the BS Reader when necessary. The WTRU Reader 810 and the BS Read 820 perform an RRC Connection Request/Accept procedure (signal 2). The RRC Configuration message may include the predefined time slot information to the WTRU Reader (signal 3).

In one embodiment, the WTRU Reader, after receiving the time slot information for AIoT service related procedures, may start monitoring those time slots for AIoT device responses, regardless of whether the BS Reader has actually initiated DL triggering on those time slots. Alternatively, the WTRU Reader may wait for a further signal or indication from the BS Reader prior to the BS Reader transmitting a DL Triggering occurrence to an AIoT device. For example, this further indication may be sent by the BS Reader using a Paging procedure.

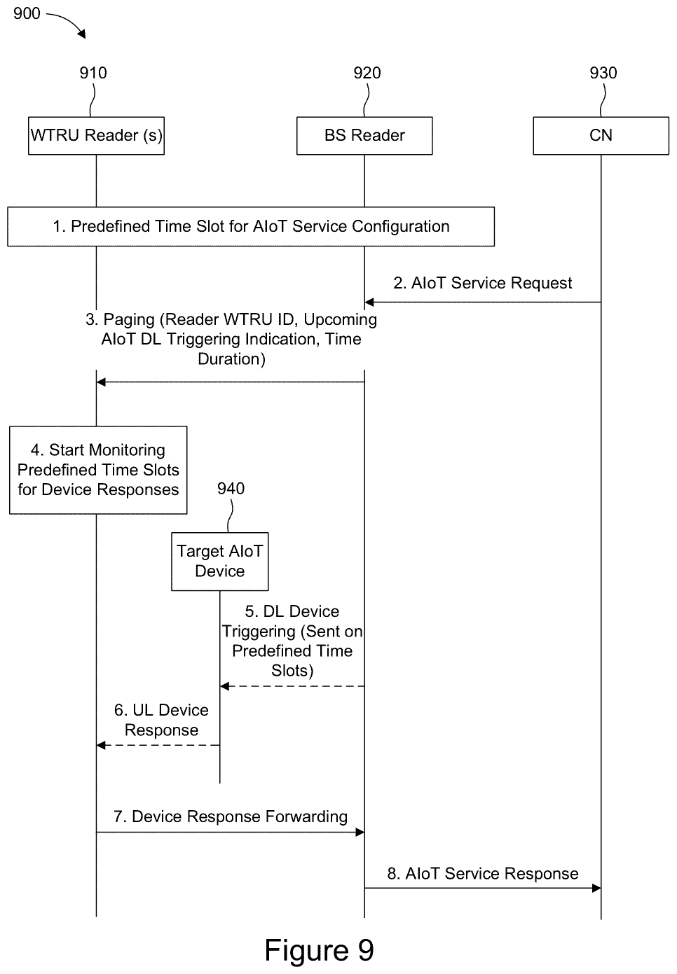

FIG. 9 shows a signal flow diagram 900 of an example procedure in which a core network (CN) 930, a BS Reader 920, and a WTRU Reader 930 coordinate using predefined time slots to send DL device triggering message to an AIoT device 940 and receive UL device responses. To begin, the WTRU Reader 910 that's in the coverage area of the BS Reader 920 may be configured with predefined times slots for AIoT service information by the BS Reader 920, for example, using the procedure described above with reference to FIG. 8 (step 1). The CN 930 sends an AIoT service request (for example, an inventory request) to the BS Reader 920 (signal 2). The BS Reader 920 initiates a Paging procedure to notify the WTRU Readers 910 that the BS Reader 920 is going to perform DL Triggering at a next predefined time slot(s) and the WTRU Readers 910 should be prepared for monitoring possible AIoT device 940 responses in those time slots. The Paging message (signal 3) will be broadcasted in the Paging Occasions corresponding to the WTRU Readers' identifiers. The BS Reader 920 may include in the Paging message one or multiple WTRU Reader identifiers (based on the list of available WTRU Readers that it maintains, as described in FIG. 5 above). The BS Reader 920 may also indicate, in the Paging message, a time duration that the WTRU Readers 910 should keep monitoring for AIoT device responses.

The BS Reader 920 may also include “device response filter” information in the Paging message. The response filter may include information such as a device identifier, and/or a transaction number or AIoT service identifier, which may be expected in the device response message. The WTRU Reader 910 may determine, based on whether the received device response information includes the expected response filter information, whether the received device response is relevant. The WTRU Reader 910 may drop received device responses if they don't include the expected information, e.g. the expected device identifier.

Upon detecting the Paging message, the WTRU Reader(s) 910 will start monitoring for possible AIoT device responses in the frequency spectrum assigned for AIoT service (step 4). Because this Paging is a special Paging procedure for the purpose of alerting the WTRU Readers, the WTRU Readers don't need to respond to the Paging message.

The BS Reader 920 sends the DL Triggering message to the target AIoT device 940 at the next predefined time slot(s) (signal 5). The BS Reader 920 may repeat the same triggering message in one time slot of multiple time slots. The WTRU Reader(s) 910 receives an AIoT device response message transmitted by the Target AIoT device 940 in response to receiving the DL Triggering message in one predefined time slot (signal 6). If a device response filter information is provided at described above, the WTRU Reader(s) 910 may check if the received UL device response message includes the expected information. If not, the WTRU Reader(s) 910 may consider the received UL device response irrelevant and drop the message.

If the WTRU Reader(s) 910 determines that the received UL device response is relevant, it may forward the received UL response message to the BS Reader 920 (signal 7). If the WTRU Reader(s) 910 is in IDLE mode, it may need to establish an RRC connection prior to forwarding the UL response message via an RRC message. In addition to the received UL response message, the WTRU Reader(s) 910 may provide other information, such as timestamp information (for example, the SFN number) of the received UL device response, the current location (for example, GPS coordinates) of the WTRU Reader(s) 910, and/or other similar information. The BS Reader 920 may include this additional information in the AIoT service response message sent to the CN 930 and AIoT application server. The CN may use the information to form the association between the WTRU Reader and the AIoT devices that the WTRU Reader has access to. This association information may be used by the CN in future AIoT service procedures, for example to determine which WTRU Reader is used to handle a AIoT service request.

Finally, the BS Reader 920 then may construct a AIoT service response message based on received UL device response message and forward the AIoT service response message to the AIoT application server through the CN 930 (signal 8). It is possible that the BS Reader 920 may receive duplicated UL device responses from multiple WTRU Reader(s) 910, and the BS Reader 920 will handle the duplication and send a single AIoT Service Response to the application server.

In some embodiments, if the BS Reader has not configured predefined time slots for AIoT service in the WTRU Readers in advance, the BS Reader may do so prior to initiating DL triggering. For example, the BS Reader may provide time slot information for AIoT service information in an RRC Configuration message (as described in FIG. 8 above).

The solutions described above, which allows WTRU Readers to assist the reception of AIoT device responses, may also be used in combination with a normal AIoT triggering procedure. For example, the BS Reader may initiate the DL triggering and attempt to receive the device responses on its own first, and if that fails, the BS Reader may activate the WTRU Readers in its coverage and let them assist in receiving the AIoT UL device responses.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in a wireless transmit/receive unit (WTRU), the method comprising:
receiving, from a base station (BS) reader, a request for an AIoT WTRU reader to perform a check-in procedure;
transmitting, to the BS reader, a radio resource control (RRC) connection request message including an indication of WTRU reader capabilities; and
receiving, from the BS reader, an RRC connection accept message indicating the WTRU will perform WTRU reader functionality.

2. The method of claim 1, wherein the request for an AIoT WTRU reader to perform a check-in procedure is a system information broadcast (SIB) message.

3. The method of claim 1, wherein the RRC connection request message enables the BS reader to construct a list of available WTRU readers.

4. The method of claim 1, wherein the RRC connection request message includes a WTRU identifier, a 5G shortened temporary mobile subscriber identity (5G-S-TMSI), an application layer reader identifier, a supported AIoT service identifier, or a WTRU reader location.

5. The method of claim 1, wherein the RRC connection request message includes an AIoT device identifier of an AIoT device associated with the WTRU.

6. The method of claim 1, further comprising:
receiving, from the BS reader, time slot configuration information indicating a time slot in which the BS reader will transmit to an AIoT device.

7. The method of claim 6, wherein the time slot configuration information is received from the BS reader as part of a paging procedure.

8. The method of claim 6, further comprising:
receiving, from the BS reader, a paging message indicating the BS reader will transmit to the AIoT device in a next predefined time slot according to the time slot confirmation information.

9. The method of claim 8, further comprising:
monitoring, during the indicated next predefined time slot, for a response message from the AIoT device.

10. The method of claim 9, further comprising:
receiving, from the AIoT device, an uplink response message responsive to a downlink device triggering message transmitted by the BS reader; and
transmitting, to the BS reader, the received uplink response message.

11. A wireless transmit/receive unit (WTRU) comprising:
a transmitter;
a receiver; and
at least one processor, wherein the transmitter, the processor, and the at least one processor are configured to:
receive, from a base station (BS) reader, a request for an AIoT WTRU reader to perform a check-in procedure;
transmit, to the BS reader, a radio resource control (RRC) connection request message including an indication of WTRU reader capabilities; and
receive, from the BS reader, an RRC connection accept message indicating the WTRU will perform WTRU reader functionality.

12. The WTRU of claim 11, wherein the request for an AIoT WTRU reader to perform a check-in procedure is a system information broadcast (SIB) message.

13. The WTRU of claim 11, wherein the RRC connection request message enables the BS reader to construct a list of available WTRU readers.

14. The WTRU of claim 11, wherein the RRC connection request message includes a WTRU identifier, a 5G shortened temporary mobile subscriber identity (5G-S-TMSI), an application layer reader identifier, a supported AIoT service identifier, or a WTRU reader location.

15. The WTRU of claim 11, wherein the RRC connection request message includes an AIoT device identifier of an AIoT device associated with the WTRU.

16. The WTRU of claim 11, wherein the receiver is further configured to:
receive, from the BS reader, time slot configuration information indicating a time slot in which the BS reader will transmit to an AIoT device.

17. The WTRU of claim 16, wherein the time slot configuration information is received from the BS reader as part of a paging procedure.

18. The WTRU of claim 16, wherein the receiver is further configured to:
receive, from the BS reader, a paging message indicating the BS reader will transmit to the AIoT device in a next predefined time slot according to the time slot confirmation information.

19. The WTRU of claim 18, wherein the at least one processor and the receiver are further configured to:
monitor, during the indicated next predefined time slot, for a response message from the AIoT device.

20. The WTRU of claim 19, wherein the receiver and the transmitter are further configured to:
receive, from the AIoT device, an uplink response message responsive to a downlink device triggering message transmitted by the BS reader; and
transmit, to the BS reader, the received uplink response message.
